(19) United States
(12) Patent Application Publication
(10) Pub. No.: US 2023/0079411 A1
(43) Pub. Date: Mar. 16, 2023

(54) Exoskeleton Fitness Device for Exercising the Human Body

(71) Applicant: NCTE AG, Oberhaching (DE)

(72) Inventor: Günter Pröpster, München (DE)

(21) Appl. No.: 17/944,643

(22) Filed: Sep. 14, 2022

(30) Foreign Application Priority Data
Sep. 16, 2021 (EP) 21197141.1

(51) Int. Cl. A61H 3/00; A63B 21/005

(52) U.S. Cl. CPC A61H 3/00; A63B 21/005; A61H 2003/007; A61H 2201/5069; A61H 2201/5061; A61H 2201/165

(57) ABSTRACT

An exoskeleton fitness device, particularly for exercising a human body, comprises a wearable structure having at least one fastening member, the at least one fastening member configured to fasten the wearable structure to a user's body, at least one mechanical joint having at least one axis of rotation and at least one degree-of-freedom, the at least one mechanical joint fastened to the wearable structure, at least one unit for generating a rotational resistance that counteracts a rotational movement of the at least one mechanical joint, and a controller for controlling the rotational resistance, wherein the controller is configured to control the rotational resistance according to a user setting.

### CROSS-REFERENCE TO RELATED APPLICATION(S)

This application claims priority to European Application Patent Serial No. EP 21 197 141.1, filed Sep. 16, 2021, the entire disclosure of which is hereby incorporated by reference.

### TECHNICAL FIELD

The present invention relates to a wearable fitness and/or training device for a versatile use, which is configured as an exoskeleton and can be worn on the body by the user. By employing a controller, the resistance to movement applied to the individual limbs can be dynamically adjusted, thus simulating “virtual weights”.

### BACKGROUND

From the prior art there are known, for example, artificial, machine exoskeletons that take the form of support robots that can be worn on the body. In this respect the Exoskeleton does not form a direct part of the carrying body, but supports and amplifies its movements with the aid of mechanical power. Active drive components of the exoskeleton contribute to force reduction and load reduction. Mechanical assistance is often provided by spring actuators. However, other actuators such as electric motors, pneumatic or hydraulic drives can also be used. Exoskeletons are used, for example, in industry for physically demanding activities to support workers. Another example of a field in which exoskeletons are used is orthopedics. In the orthopedic field, exoskeletons are used as orthopedic aids. On the one hand, exoskeletons can be used as a relief for the limbs. On the other hand, however, exoskeletons can also assume the function of active prostheses.

In the fitness sector, where increasing physical performance and/or building muscles through targeted training is the goal, there exists a wide range of fitness equipment. For example, there are known training devices that require a fixed installation site and with it a corresponding amount of space, such as weight stations, treadmills or ergometers. Furthermore, there are known training devices that can adjust and dynamically change the mechanical resistance of the training device to be overcome during training. For example, it is possible to simulate a terrain slope on treadmills or ergometers. Nevertheless, all these training devices have the disadvantage that they require a fixed installation site and must be operated stationary. Although training devices that do not require a fixed installation site can be used flexibly, they have the disadvantage that they are usually used without a specialist's instruction and can therefore lead to damage and injury to the user if used improperly.

It is therefore the underlying object of the present invention to provide a fitness device that provides a user with a challenging workout opportunity without requiring a fixed location for the fitness device, and that minimizes a risk of improper use.

### SUMMARY

Said task is solved by an exoskeleton fitness device that facilitates a directed restriction of a user's physical movement ability. More specifically, said task is solved by providing an exoskeleton fitness device, in particular for exercising the human body, comprising a wearable structure with at least one fastening member, wherein said at least one fastening member is adapted to fasten said wearable structure to the body of a user. Further, the exoskeleton fitness device of the invention comprises at least one mechanical joint having at least one axis of rotation and at least one degree-of-freedom, wherein the at least one mechanical joint is fastened to the wearable structure. Furthermore, the exoskeleton fitness device according to the invention comprises at least one unit for generating a rotational resistance counteracting a rotational movement of the at least one mechanical joint, and a controller for controlling the rotational resistance, wherein the controller is adapted to control the rotational resistance according to a user setting.

The exoskeleton fitness device according to the invention comprises a mechanical structure worn on the body of a user. The exoskeleton fitness device can be an exoskeleton worn on the entire body or only on a specific part of the body, such as the back, legs, or arms. The exoskeleton fitness device can be a combination of two or more exoskeleton fitness devices. For example, an exoskeleton fitness device for a left arm may be combined with an exoskeleton fitness device for a right arm, or an exoskeleton fitness device for a left arm may be combined with an exoskeleton fitness device having a left leg. An exoskeleton fitness machine can be shaped for an upper body or for the hips and legs. Any combination with a different number of exoskeleton fitness devices is conceivable.

The exoskeleton fitness device includes a wearable structure. The wearable structure may include one or more parts. When the wearable structure is worn by a user, at least a part of the wearable structure may be disposed parallel to a limb of the user. The wearable structure can contain various materials.

The wearable structure is fastened to the user's body with fastening members. The fastening members may be removably or non-removably connected to the wearable structure. The fastening members can each consist of one component or of a plurality of components. The fastening members may include rigid components and/or flexible components and/or straps and/or belts. The fastening members can include various materials such as textiles, plastics and metals. The fastening members may be configured to fasten the wearable structure to the user's body so that the at least one mechanical joint is positioned on the user's body so that the at least one mechanical joint is at the level of a body joint and is aligned so that the axis of rotation of the mechanical joint coincides with the axis of rotation of the body joint. At least a part of the wearable structure may be disposed parallel to the body part that includes the body joint.

The exoskeleton fitness device further comprises at least one mechanical joint fastened to the wearable structure. The mechanical joint rotatably connects two parts of the wearable structure. The mechanical joint has at least one axis of rotation and at least one degree-of-freedom. The number of degrees-of-freedom indicates in how many planes a rotational movement around a rotational axis of the mechanical joint is possible. The mechanical joint can have several degrees-of-freedom. For example, if the mechanical joint has only a single degree-of-freedom, the mechanical joint has only one axis of rotation. A rotary movement is only possible around this one axis of rotation. The rotary motion is performed in one plane. The number of planes in which rotary motion is allowed by the mechanical joint corresponds to the number of degrees-of-freedom of the mechanical joint and the number of axes of rotation that the mechanical joint has. If the number of degrees of freedom is 3, for example, the mechanical joint has 3 axes of rotation and 3 planes are defined in which rotary motion about an axis of rotation is possible. The mechanical joint can be, for example, a rotary joint or a universal joint. A universal joint is an angularly movable connection between two shafts. The angular mobility provides a large number of degrees-of-freedom. Other types of mechanical joints can also be used with the invention.

The exoskeleton fitness device further comprises at least one unit for generating rotational resistance. The rotational resistance counteracts a rotational movement of the at least one mechanical joint. The rotational resistance brakes the rotational movement of the mechanical joint.

The exoskeleton fitness device also includes a controller for controlling the rotational resistance according to a user setting. The user setting is a setting that the user can adopt as a default or change according to their needs. For example, the user can adjust the rotational resistance that the user must overcome when moving the exoskeleton fitness device about a rotational axis of a body joint, and thus about the rotational axis of the mechanical joint. The controller can control the rotational resistance in any plane in which rotational movement about a rotational axis of the mechanical joint is possible. The controller can control the rotational resistance in such a way that the rotational resistance remains constant or is changed dynamically. Here, control means an electronic controller that contains at least one processor and/or microprocessor. The controller may include an electronic memory.

The at least one unit for generating a rotational resistance may further comprise an electric motor, a pneumatic drive, or a hydraulic drive. The electric motor, pneumatic or hydraulic drive can provide the power for the rotational resistance to brake the rotary motion. The exoskeleton fitness device according to the invention may comprise a radio module with an antenna for wireless transmission of data between the controller and a mobile terminal.

The advantage of the exoskeleton fitness device according to the invention is that the exoskeleton fitness device can be used flexibly. A fixed installation site is not required. With all the flexibility of the exoskeleton fitness device according to the invention, a risk of improper use is minimized. In particular, the wearable structure and the fastening members ensure that the position of the mechanical joint corresponds to a position of the body joint and that the axis of rotation of the mechanical joint corresponds to the axis of rotation of the body joint. Moreover, if lightweight yet strong materials are used, an exoskeleton fitness device can be made that is much lighter compared to the already known exoskeletons.

According to the invention, the wearable structure may further comprise a first part and a second part, wherein the first part and the second part are rotatably connected to each other via the mechanical joint. The first part and the second part may each extend along a part of the body. For example, the first part and the second part may be shaped as rails, shells, struts, or grids that are positioned along the body part and parallel to the body part by the fastening members. The first part and the second part may be formed by a combination of rails and/or shells and/or struts and/or grids. The rails can be straight in shape or have a slight curvature adapted to a curve of the body part. The shells can be formed according to an outer shape of the body part. The first part and the second part may be shaped to cover, partially enclose, or completely enclose the body part. The first part and the second part may each be formed in a single piece or from a plurality of pieces. When the first part and the second part are formed as struts, each part may have at least one strut. The first part and the second part may be formed of a rigid material. The first part and the second part may be formed of a combination of rigid and more elastic materials.

According to the invention, the exoskeleton fitness device may be configured so that the at least one axis of rotation of the at least one mechanical joint coincides with an axis of rotation of a body joint of the user.

According to a further embodiment, the wearable structure may further be configured to enable a movement sequence performed by at least one body part of the user, in particular from a left shoulder and/or a right shoulder and/or a torso and/or a left arm and/or a right arm and/or a left upper arm and/or a right upper arm and/or a left lower arm and/or a right lower arm and/or a left hand and/or a right hand and/or at least one finger and/or a left hip and/or a right hip and/or a left leg and/or a right leg and/or a left knee and/or a right knee and/or a left foot and/or a right foot.

According to a further development of the exoskeleton fitness device according to the invention, the at least one unit for generating the rotational resistance comprises an electrically controllable brake.

According to a further embodiment, the exoskeleton fitness device of the invention may further comprise at least one position sensor positioned at a joint of the body when the structure is worn and configured to detect positional data of the movement sequence. The at least one position sensor may be provided on the at least one mechanical joint to sense an angle of rotation about the axis of rotation. The position data can be recorded, forwarded to the controller and/or stored. The controller can compare the received position data with stored data of a motion specification. The exoskeleton fitness device according to the invention may comprise a radio module with an antenna for wireless transmission of data between the position sensor, the controller and a mobile terminal.

According to a further embodiment, the exoskeleton fitness device may further comprise at least one optical marker. The at least one optical marker may be provided on the wearable structure and/or on the at least one mechanical joint. The optical marker can be detected by a camera. The camera can record a motion sequence of the user while wearing the exoskeleton fitness device with position measurement using the optical marker. The motion sequence can be captured either by the camera or by the position sensor. The motion sequence can be captured simultaneously by the camera and the position sensor. The resulting data can be stored and evaluated by the controller.

According to a further embodiment, the exoskeleton fitness device may include at least one pair of mechanical joints having coinciding axes of rotation. For example, the pair of mechanical joints may be arranged in pairs at a level of a body joint of a limb so that one mechanical joint is positioned on an inner side of the limb adjacent the body joint and the other mechanical joint is positioned on an outer side of the limb adjacent the body joint.

According to a further embodiment of the exoskeleton fitness device according to the invention, the two mechanical joints of the pair are arranged in correspondence to a position of a body joint of the user opposite to each other on the wearable structure so that the body joint is positioned at their center. In other words, the body joint may be located between the two mechanical joints, and the axes of rotation of the two mechanical joints and the body joint may be aligned with each other.

According to a further embodiment of the exoskeleton fitness device of the invention, the controller is further configured to control the at least one rotational resistance as a function of an angular force applied by the user.

According to a further embodiment, the exoskeleton fitness device may further comprise at least one torque sensor, in particular at least one magnetostrictive torque sensor, for measuring the angular force applied by the user. The torque sensor may be a magnetostrictive torque sensor comprising a shaft that is magnetized in a first axial portion in a first circumferential direction, and to which a torque to be measured may be applied. Such a torque sensor may further comprise a first magnetic field sensor for sensing a magnetic field outside the shaft generated by the first portion of the shaft, dependent on the applied torque. The first magnetic field sensor may comprise a first 3D AMR sensor. Such a torque sensor is described in detail in patent application EP3364163A1. The torque sensor may be a magnetostrictive torque sensor having a hollow shaft magnetized in a first axial portion in a first circumferential direction and to which a torque to be measured is applicable, and a first magnetic field sensor for detecting a magnetic field generated by the first portion of the hollow shaft outside the hollow shaft. Such a torque sensor is described in detail in European patent application EP3232172A1. The torque sensor may be a disk sensor comprising a disk comprising a magnetostrictive, premagnetized, or magnetizable material and a magnetic field sensor assembly. A torque acting about an axis of rotation of the disc can be applied to the disc. The magnetostrictive material is designed to generate a magnetic field outside the disk that can be varied as a function of the acting torque. The magnetic field sensor assembly outputs a signal based on the magnetic field generated by the magnetostrictive material. The torque sensor determines a value of the acting torque on the basis of the output signal. A disc, which acts as a force-transmitting element, is used to measure the applied torque by premagnetizing the disc. In this way, the disk, rather than a shaft on which the disk can be placed, is used as the primary sensor (magnetized region). Such a disc sensor is described in detail in European patent application EP21183622.6.

The exoskeleton fitness device according to the invention may comprise a radio module with an antenna for wireless transmission of data between the torque sensor, the controller and a mobile terminal.

The measurement data of the angular force applied by the user can be transmitted to the controller. The controller can control the rotational resistance depending on the angular force measurement data.

The present invention also provides a method, in particular for exercising the human body, using an exoskeleton fitness device. The method includes the following steps: Fastening a wearable structure of the exoskeleton fitness device to the body of a user by means of at least one fastening member, generating a rotational resistance counteracting a rotational movement of a mechanical joint, wherein the mechanical joint comprises at least one axis of rotation and at least one degree of freedom, and wherein the at least one mechanical joint is fastened to the wearable structure, and controlling the rotational resistance by means of a controller according to a user setting.

According to a further embodiment, the method further comprises the following steps: Performing, by means of the wearable structure, an angular movement by the user centered on a body joint of the user, measuring an angular force applied by the user by means of a torque sensor, and wherein the controlling further comprises controlling the at least one rotational resistance in response to the measured angular force.

Further features and exemplary embodiments as well as advantages of the present invention are explained in more detail below with reference to the drawings. It is understood that the embodiments do not exhaust the scope of the present invention. It is further understood that some or all of the features described below may also be combined in other ways.

### BRIEF DESCRIPTION OF THE DRAWINGS

FIG. 1 is a schematic diagram of an exemplary exoskeleton fitness device according to the present invention on a user.

FIG. 2 is a schematic view of a wearable structure and a mechanical joint according to the present invention.

FIG. 3 is a schematic view of a mechanical joint according to the present invention.

FIG. 4 is a schematic view of a mechanical joint according to the present invention.

FIG. 5 shows a structure diagram of a process.

### DETAILED DESCRIPTION

In the figures described below, identical reference numbers refer to the same elements. For clarity, identical elements are described only on their first occurrence. However, it is understood that the variations and embodiments of an element described with reference to one of the figures may also be applied to the corresponding elements in the remaining figures.

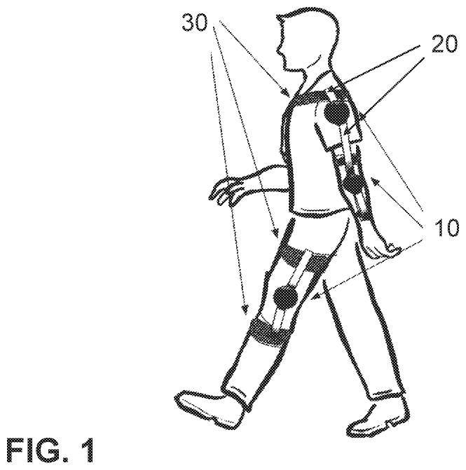

FIG. 1 schematically illustrates an exemplary exoskeleton fitness device according to the present invention on a user. Without limiting the generality, an exoskeleton fitness device for an arm and a leg are illustrated in FIG. 1. The exoskeleton fitness device may be configured to replicate natural limb movement patterns when worn. This means that, for example, the arms and/or legs can be moved freely while wearing the exoskeleton fitness device. Further, the exoskeleton fitness device may be configured to replicate only a part of the natural limb movement patterns when the exoskeleton fitness device is worn. This means that, for example, the arms and/or legs can be restricted to certain levels of movement when wearing the exoskeleton fitness device.

In the human body, different types of joints are distinguished according to their shape and the possibility of movement given by the shape. The respective shape of the body joint determines the number of degrees of freedom. The number of degrees of freedom indicates in how many planes of motion a rotational movement is made possible by the body joint. The number of movement planes corresponds to the number of degrees of freedom. For example, a ball joint consists of a spherical joint head that slides in a socket shaped like a hollow sphere. Ball joints have a practically infinite number of joint axes and accordingly allow all-round mobility. For example, the shoulder joint and the hip joint are ball and socket joints. Another example of a joint that occurs in the human body is a hinge joint. The hinge joint consists of a channel and a matching roller. A hinge joint has only one degree-of-freedom, which allows movement about only one axis, namely the hinge axis, in only one plane of motion. Finger-middle joints and finger-end joints, for example, are hinge joints. However, the mobility of the human body is not only caused by the body joints alone. In order for a person to move, an interaction of muscles and joints is necessary. According to the present invention, for example, muscle strengthening is achieved by using the exoskeleton fitness device according to the invention.

In the embodiment of FIG. 1, the exoskeleton fitness device includes three mechanical joints 10 and a wearable structure 20 with a plurality of fastening members 30. In the exoskeleton fitness device shown in FIG. 1, the wearable structure 20 is fastened to the user's body so that a mechanical joint 10 is positioned at each of the user's knee, elbow, and shoulder. Each of the mechanical joints 10 shown in FIG. 1 rotatably connects a first part and a second part of the wearable structure 20. “Rotatable” means that the mechanical joint 10 allows the first part 21 and the second part 22 of the wearable structure 20 fastened to the user's body to perform an angular movement about the axis of the mechanical joint. One end of each of the first part 21 and/or the second part 22 of the wearable structure 20 may be rotatably connected to a mechanical joint 10, and one end of each longitudinally opposite end may be connected to another mechanical joint 10. FIG. 1 shows that a part of the wearable structure 20 is connected to both the mechanical joint 10 positioned at the user's shoulder joint and the mechanical joint 10 positioned at the elbow joint. For example, a part of the wearable structure 20 extending along a thigh may be connected to a mechanical joint 10 positioned at the knee and to a mechanical joint 10 positioned at the hip. A part of the wearable structure 20 extending along a lower leg may be connected to a mechanical joint 10 positioned at the knee and to a mechanical joint 10 positioned at the ankle. The list of examples does not claim to be exhaustive.

As shown in FIG. 1, the wearable structure 20 and the mechanical joints 10 are disposed on an outer side of the limbs facing away from a center of the user's body. The mechanical joints are fastened to the wearable structure so that the position of each mechanical joint of the exoskeleton fitness device corresponds to the position of a body joint. The parts 21, 22 of the wearable structure 20 connected by a mechanical joint 10 are arranged so that the parts 21, 22 are parallel to a body axis or limb of the user. In FIG. 1, the parts 21, 22 of the wearable structure 20 are arranged to extend along and parallel to the outside of an arm and leg, respectively. The parts 21, 22 of the wearable structure 20 and the mechanical joints 10 may be arranged on an inner side of the limbs, i.e., on a side of the limbs that is located toward the center of the body. The parts 21, 22 of the wearable structure 20 and the mechanical joints 10 may be arranged on an outer side and an inner side of the limbs, respectively. The exoskeleton fitness device according to the invention may comprise at least one pair of mechanical joints 10 whose axes of rotation coincide. The mechanical joints 10 and/or the parts 21, 22 of the wearable structure 20 may be arranged in pairs. That is, mechanical joints 10 and parts 21, 22 of the wearable structure 20 are arranged in pairs on the inside and outside of the limbs. An exoskeleton fitness device according to the invention may have further mechanical joints 10 at positions each corresponding to the position of a body joint. For example, a respective mechanical joint 10 may be positioned at the ankle and/or wrist and/or finger joints and/or hip and/or shoulder blade of the user's body. For example, when a mechanical joint 10 is positioned at one of two shoulder blades on a user's back, a first part 21 of the wearable structure 20 may extend from the mechanical joint 10 along a back side of an upper arm of the user parallel to the upper arm. The length of the first part 21 may be determined to allow bending of the elbow. Nevertheless, the length of the first part 21 can also be determined in such a way that it is no longer possible to bend the elbow. A second part 22 of the wearable structure 20 may extend from the mechanical joint 10 along the user's back toward the ground.

The exoskeleton fitness device according to the invention may comprise one or more position sensor(s). A position sensor is placed on a joint of the body when the structure is worn. The position sensor captures position data of the motion sequence that the user performs with the corresponding body part where the position sensor is located. With a position sensor, the movement of an object can be detected and converted into suitable signals for processing, transmission and control. For example, position measurement solutions include inductive, potentiometric, magnetoresistive and capacitive measurements. In the exoskeleton fitness device of the invention, the wearable structure may comprise an optical marker detected by a camera. A sequence of movements performed by the user with different body parts can be filmed, analyzed and controlled.

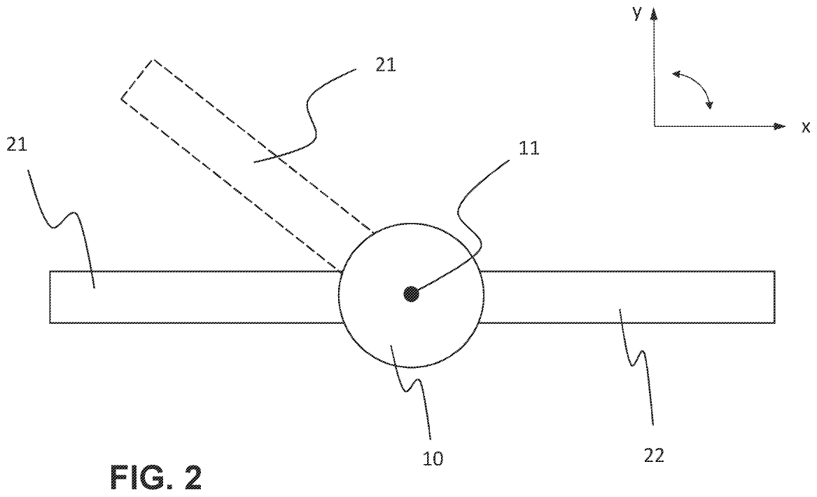

FIG. 2 shows a mechanical joint 10 that includes an axis of rotation 11. In FIG. 2, the diagram in the upper right illustrates a plane defined by the xy axes in which rotational movement about the axis of rotation 11 of the mechanical joint 10 can occur. FIG. 2 further shows a schematic view in the direction of the axis of rotation 11 of the mechanical joint 10. The mechanical joint 10 shown schematically in FIG. 2 rotatably connects a first part 21 and a second part 22 of the wearable structure 20 of the exoskeleton fitness device according to the invention. The fastening members 30 have been omitted from FIG. 2 for clarity. In FIG. 2, a rotational movement of the first part 21 about the axis of rotation 11 is indicated by dashing. Without rotary motion, the first part 21 and the second part 22 are in an elongated form. “Stretched shape” here means that the first part 21 and the second part 22, which are rotatably connected to each other via the mechanical joint 10, form an angle of 180 degrees. For example, the stretched shape corresponds to stretched limbs of the human body. For example, a user may move the exoskeleton fitness device about the axis of rotation of a body joint. The axis of rotation 11 of the mechanical joint 10 coincides with the axis of rotation of the body joint. A rotational resistance counteracts a rotational movement of the mechanical joint 10. Therefore, the rotational movement to which, for example, the first part 21 of the wearable structure 20 is subjected by the user is slowed down.

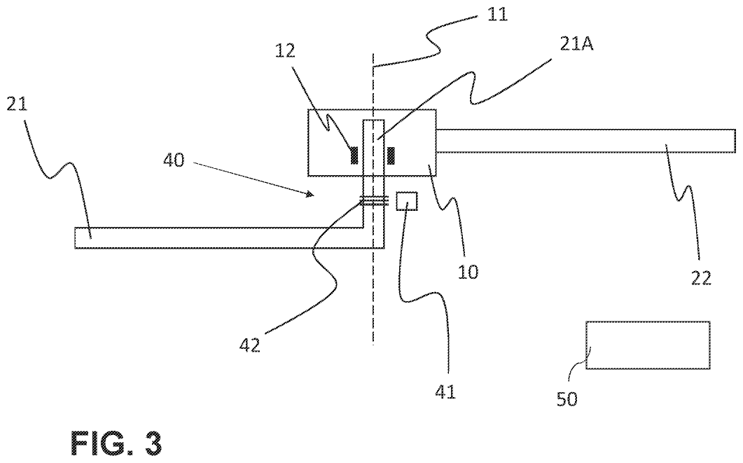

FIG. 3 shows schematically the mechanical joint 10 according to the present invention. The mechanical joint 10 includes the axis of rotation 11. FIG. 3 further shows a unit 12 for generating a rotational resistance. For example, a braking force acts on the angled region 21A of the first part 21 of the wearable structure 20 to cause the rotational resistance. In the following, the angled region 21A is referred to as shaft 21A. The unit 12 generates the rotational resistance, which is controlled by a controller 50 according to a user setting. The generated rotational resistance counteracts a rotational movement of the mechanical joint 10. Therefore, the rotational movement to which, for example, the first part 21 of the wearable structure 20 is subjected by the user is slowed down. FIG. 3 further shows a torque sensor 40 that measures the angular force applied by the user. The torque sensor 40 includes a magnetic field sensor 41 and a magnetized region 42 of the angled region of the first part 21 (shaft 21A). When the first part 21 of the wearable structure is subjected to rotational movement about the rotational axis 11 of the mechanical joint 10, the torque applied to the rotational axis causes minimal torsion of the shaft 21A, which changes a magnetic field generated outside the shaft 21A by the magnetized region 42. The change in the magnetic field is detected by the magnetic field sensor 42. The magnetic field sensor 42 sends a signal containing information about the detected magnetic field change to the controller 50. The controller 50 processes the received information about the magnetic field change and determines a magnitude of the angular force. The determined value of the angular force is compared with a user setting. When the magnitude of the angular force deviates from the user setting, the controller 50 controls the rotational resistance generating unit 12 so that the generated rotational resistance that brakes the rotational motion is either increased or decreased according to the deviation. The controller 50 of the exoskeleton fitness device according to the invention can control the rotational resistance as a function of an angular force applied by the user. The rotational resistance can be generated by an electrically controllable brake, for example. The force to be applied by the user to rotate the exoskeleton fitness device around the axis of rotation of the body joint can be adjusted and controlled. The controller 50 may process data from a position sensor and control the variable rotational resistance accordingly. The controller 50 may process image data captured by a camera and control the rotational resistance accordingly, or feedback may be provided with a motion input.

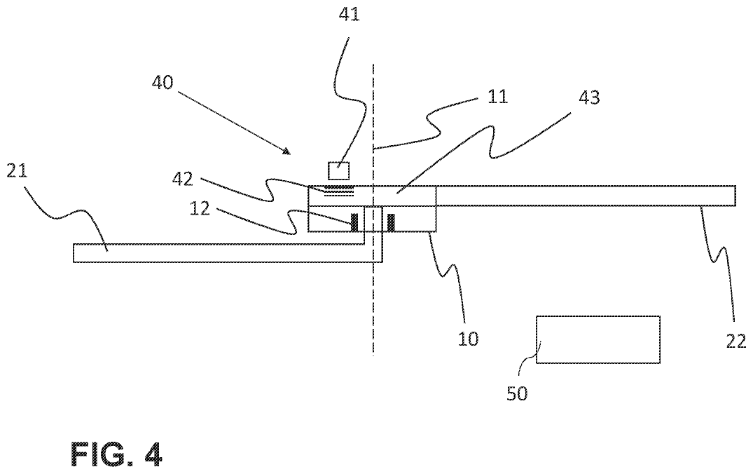

FIG. 4 shows the mechanical joint 10 also shown in FIG. 3, except that the torque sensor is a magnetostrictive disc sensor 40. The first part 21 is connected to an inner region (with respect to the radial direction) of the disk 43. The second part 22 is connected to an outer region (with respect to the radial direction) of the disk 43. The disk sensor 40 includes a disk 43 containing a magnetostrictive, premagnetized, or magnetizable material 42, and a magnetic field sensor assembly 41. The magnetostrictive material 42 is magnetized in a central region (between the inner region and outer region) of the disk 43. A torque acting about an axis of rotation of the disk can be applied to the disk 43. The magnetostrictive material 42 generates a magnetic field outside the disk 43 that can be varied as a function of the acting torque (angular force). The magnetic field sensor assembly 41 outputs a signal based on the magnetic field generated by the magnetostrictive material. The torque sensor 40 determines a value of the acting torque based on the output signal. The disc 43, which acts as a force-transmitting element, is used to measure the applied torque by premagnetizing the disc 43.

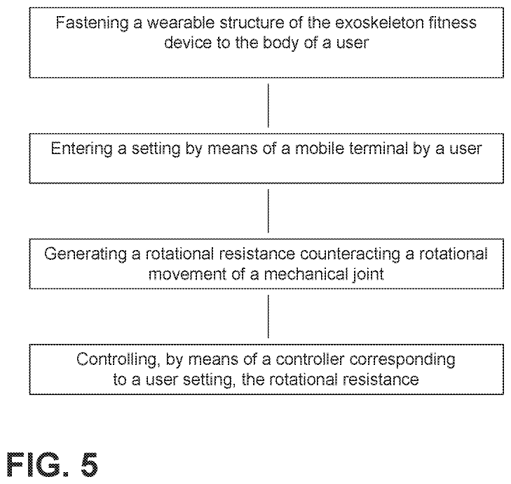

FIG. 5 shows a schematic structure for a method, in particular for exercising a human body, with an exoskeleton fitness device according to the invention. The user fastens the wearable structure 20 of the exoskeleton fitness device to their body using the fastening members 30. The position of a mechanical joint 10 corresponds to the position of a body joint. The axis of rotation 11 of the mechanical joint 10 coincides with the axis of rotation of the body joint. The user makes settings by means of a mobile terminal by entering appropriate data into the mobile terminal. The data entered by the user into the mobile terminal is transmitted to the controller 50. A rotational resistance is generated which counteracts the rotational movement of the mechanical joint. When the user moves the exoskeleton fitness device about the rotational axis of the body joint, the user must apply force to overcome the rotational resistance generated by the unit 12 that opposes rotation about the rotational axis 11 of the mechanical joint 10. The rotational resistance is controlled by the controller 50 according to the user setting. The user can perform an angular movement by means of the wearable structure, the center of which is a body joint of the user. The angular force applied by the user can be detected by means of a torque sensor. By means of a position sensor, position data of a motion sequence mapped by the wearable structure can be detected. The rotational resistance can be controlled depending on the angular force applied by the user.

The invention described allows flexible use without a fixed installation site. Any risk of improper use is minimized with full flexibility. Using lightweight yet strong materials, the weight of the exoskeleton fitness device according to the invention can be much lighter than that of the exoskeletons already known.

What is claimed is:

1. An exoskeleton fitness device for exercising a human body, comprising:
a wearable structure having at least one fastening member, wherein the at least one fastening member is configured to fasten the wearable structure to a body of a user;
at least one mechanical joint having at least one axis of rotation and at least one degree-of-freedom, wherein the at least one mechanical joint is fastened to the wearable structure;
at least one unit for generating a rotational resistance which counteracts a rotational movement of the at least one mechanical joint; and
a controller for controlling the rotational resistance, wherein the controller is configured to control the rotational resistance according to a user setting.

2. The exoskeleton fitness device according to claim 1, wherein the wearable structure further comprises a first part and a second part, the first part and the second part being rotatably connected to each other via the at least one mechanical joint.

3. The exoskeleton fitness device according to claim 1, wherein the at least one axis of rotation of the at least one mechanical joint coincides with an axis of rotation of a body joint of the user.

4. The exoskeleton fitness device according to claim 1, wherein the wearable structure is further configured to enable a movement sequence performed by at least one body part of the user, the at least one body part selected from a left shoulder, a right shoulder, a torso, a left arm, a right arm, a left upper arm, a right upper arm, a left lower arm, a right lower arm, a left hand, a right hand, at least one finger, a left hip, a right hip, a left leg, a right leg, a left knee, a right knee, a left foot and a right foot.

5. The exoskeleton fitness device according to claim 1, wherein the at least one unit for generating the rotational resistance comprises an electrically controllable brake.

6. The exoskeleton fitness device according to claim 1, further comprising at least one position sensor positioned at a joint of the body when the exoskeleton fitness device is worn and adapted to detect positional data of motion sequence, wherein the at least one position sensor is provided at the at least one mechanical joint to detect a rotation angle about the at least one axis of rotation.

7. The exoskeleton fitness device according to claim 1, wherein one or both of the wearable structure and the at least one mechanical joint further comprises at least one optical marker.

8. The exoskeleton fitness device according to claim 1, wherein the at least one mechanical joint is a pair of mechanical joints whose axes of rotation coincide.

9. The exoskeleton fitness device according to claim 8, wherein mechanical joints of the pair of mechanical joints are arranged in correspondence to a position of a body joint of the user opposite to each other on the wearable structure so that the body joint is positioned at their center.

10. The exoskeleton fitness device according to claim 1, wherein the controller is further configured to control the rotational resistance as a function of an angular force applied by the user.

11. The exoskeleton fitness device according to claim 1, further comprising at least one torque sensor for measuring an angular force applied by the user.

12. The exoskeleton fitness device according to claim 11, wherein the at least one torque sensor is a magnetostrictive torque sensor.

13. The exoskeleton fitness device according to claim 12, wherein the magnetostrictive torque sensor comprises a magnetic field sensor and a magnetized shaft or a magnetized disk.

14. A method for exercising a human body, with an exoskeleton fitness device, the method comprising:
fastening a wearable structure of the exoskeleton fitness device to the body of a user by means of at least one fastening member;
generating a rotational resistance counteracting a rotational movement of a mechanical joint, wherein the mechanical joint comprises at least one axis of rotation and at least one degree-of-freedom, and wherein the at least one mechanical joint is fastened to the wearable structure; and
controlling, by means of a controller according to a user setting, the rotational resistance.

15. The method according to claim 14, further comprising:
performing, by means of the wearable structure, an angular movement by the user, a center of which is a body joint of the user;
measuring an angular force applied by the user by means of a torque sensor; and
wherein the controlling further comprises controlling the at least one rotational resistance as a function of the measured angular force.
